(19) United States
(12) Patent Application Publication
(10) Pub. No.: US 2023/0347372 A1
(43) Pub. Date: Nov. 2, 2023

(54) SHOWER APPARATUS

(71) Applicant: Xiamen Prime Shower Co.,Ltd., Xiamen (CN)

(72) Inventor: Qin YU, Xiamen (CN)

(21) Appl. No.: 18/349,376

(22) Filed: Jul. 10, 2023

(30) Foreign Application Priority Data
Apr. 20, 2023 (CN) 202310429631.4
Apr. 25, 2023 (CN) 202320966136.2

(51) Int. Cl. B05B 15/40; B05B 1/18

(52) U.S. Cl. CPC B05B 15/40; B05B 1/185

(57) ABSTRACT

The present disclosure discloses a shower apparatus, including a water passing pipeline, a filter assembly and a water outlet assembly; wherein a water inlet end of the water passing pipeline is configured to be connected with a water inlet pipe disposed on a wall; a water inlet end of the filter assembly is connected to a water outlet end of the water passing pipeline, and a water outlet end of the filter assembly is connected to a water inlet end of a hose; and a water inlet end of the water outlet assembly is connected to a water outlet end of the hose, and the water outlet assembly is hung on the water passing pipeline. The shower apparatus of the present disclosure makes a height of the water outlet assembly from the ground be not limited, and thus is more comfortable to use.

### CROSS-REFERENCE TO RELATED APPLICATIONS

This application claims the benefit of priority from Chinese Patent Applications No. 202310429631.4 filed on Apr. 20, 2023, and No. 202320966136.2 filed on Apr. 25, 2023. The content of the aforementioned application, including any intervening amendments thereto, is incorporated herein by reference in its entirety.

### TECHNICAL FIELD

The present disclosure relates to the technical field of a water outlet device, in particular to a shower apparatus.

### BACKGROUND

As shown in FIG. 1, a filter arm support device includes a water passing pipeline 10, a filter assembly 20 and a water outlet assembly 30; a water inlet end of the water passing pipeline 10 is connected with a water inlet pipe disposed on a wall; a water inlet end of the filter assembly 20 is connected to a water outlet end of the water passing pipeline 10; a water inlet end of the water outlet assembly 30 is connected to a water outlet end of the filter assembly 20, water spray is sprayed out from a water outlet end of the water outlet assembly 30, and the water outlet assembly 30 is a top spray, and the top spray includes a connecting body 301 connected to the filter assembly 20, and a water outlet panel 302, and filtered water is sprayed out by the water outlet panel 302 after passing through the connecting body 301.

Since the water passing pipeline 10 is fixedly connected with the water inlet pipe disposed on the wall, the top spray is connected with the water passing pipeline 10 through the filter assembly 20, so that a height of the top spray is lower than a height of the water passing pipeline 10, and at the same time, the top spray is installed obliquely downward, further so that a height of the top spray from the ground is limited, when a taller user uses the filter arm support device, the top spray easily touches a head, and thus the use is troublesome and uncomfortable.

### SUMMARY

The present disclosure aims to solve one of the technical problems in the above-mentioned technology at least to some extent. For this purpose, an object of the present disclosure is to propose a shower apparatus, by connecting a water outlet assembly with a filter assembly by means of a hose, and hanging the water outlet assembly which can be freely taken down, a height of the water outlet assembly is higher than a height of a water passing pipeline, so that a height of the water outlet assembly from the ground is not limited, and the water outlet assembly does not touch a head even when the filter arm support device is used by a taller user, while the water outlet assembly can be taken down when the filter arm support device is used by a shorter user, so that the shower apparatus is comfortable to use.

In order to achieve the above object, an embodiment of a first aspect of the present disclosure provides a shower apparatus, including:
a water passing pipeline, wherein a water inlet end of the water passing pipeline is configured to be connected with a water inlet pipe disposed on a wall;
a filter assembly, wherein a water inlet end of the filter assembly is connected to a water outlet end of the water passing pipeline, and a water outlet end of the filter assembly is connected to a water inlet end of a hose; and
a water outlet assembly, wherein a water inlet end of the water outlet assembly is connected to a water outlet end of the hose, and the water outlet assembly is hung on the water passing pipeline.

According to the shower apparatus in the embodiment of the present disclosure, in use, water flows through the water passing pipeline, enters the filter assembly, is filtered by the filter assembly, and enters the water outlet assembly through the hose, and water spray is sprayed out from the water outlet assembly; since the hose is connected between the filter assembly and the water outlet assembly, and the water outlet assembly is hung on the water passing pipeline, the height of the water outlet assembly is higher than the height of the water passing pipeline; thus, by connecting the water outlet assembly with the filter assembly by means of the hose, and hanging the water outlet assembly which can be freely taken down, the height of the water outlet assembly is higher than the height of the water passing pipeline, so that the height of the water outlet assembly from the ground is not limited, and the water outlet assembly does not touch the head even when the filter arm support device is used by the taller user, while the water outlet assembly can be taken down when the filter arm support device is used by the shorter user, so that the shower apparatus is comfortable to use.

In addition, the shower apparatus according to the above embodiment of the present disclosure may have the following additional features:
optionally, the water passing pipeline includes a connecting arm and a water passing body, wherein a water inlet end of the connecting arm is configured to be connected with the water inlet pipe disposed on the wall, and a ball joint is connected between a water outlet end of the connecting arm and a water inlet end of the water passing body; and a water outlet end of the water passing body is connected to the water inlet end of the filter assembly, and the water passing body is connected to the water outlet assembly.

In particular, the water outlet end of the connecting arm is connected to a connecting part of the ball joint, a ball head of the ball joint is received in a connecting nut and rotatably connected to the connecting nut, and the connecting nut is in threaded connection with the water inlet end of the water passing body.

Further, a spherical sleeve is arranged between the ball head of the ball joint and the connecting nut, and a spherical pad is arranged between the ball head of the ball joint and the water inlet end of the water passing body.

In particular, the water passing body is provided with a C-shaped hole for placing the water outlet assembly.

Further, the water outlet assembly is a shower head, wherein the shower head includes a handle, a shower head body and a water outlet panel; a water inlet end of the shower head body is connected to the handle, and a water outlet end of the shower head body is connected to the water outlet panel; and the handle is connected to the hose, and the hose is inserted into the C-shaped hole.

Optionally, the filter assembly includes a housing and a filter element disposed in the housing, wherein a water inlet end of the housing is connected to the water passing pipeline, and a water outlet end of the housing is connected to the hose.

In particular, the filter element includes a residual chlorine removal filter element, a bacteriostatic filter element, a VC filter element, a KDF filter element, a mineralization filter element, a hydrogen-rich filter element, a fluorine removal filter element, a metasilicic acid filter element, a scale inhibition filter element, an alkaline filter element, and a fragrance filter element.

Specifically, the housing is provided as a first housing and a second housing, wherein the first housing is in threaded connection with the second housing, the first housing is connected to the water passing pipeline, and the second housing is connected to the hose.

Optionally, the filter assembly is arranged at an upper side, close to the water outlet assembly, in the middle of the water passing pipeline, or the filter assembly is arranged at a lower side, away from the water outlet assembly, of the water passing pipeline, the lower side being opposite to the upper side.

Specifically, the filter assembly is arranged on a first side, adjacent to the upper side, of the water passing pipeline, or the filter assembly is arranged on a second side, adjacent to the upper side, of the water passing pipeline, the second side being opposite to the first side.

### BRIEF DESCRIPTION OF FIGURES

FIG. 1 is a schematic structural diagram in the prior art;

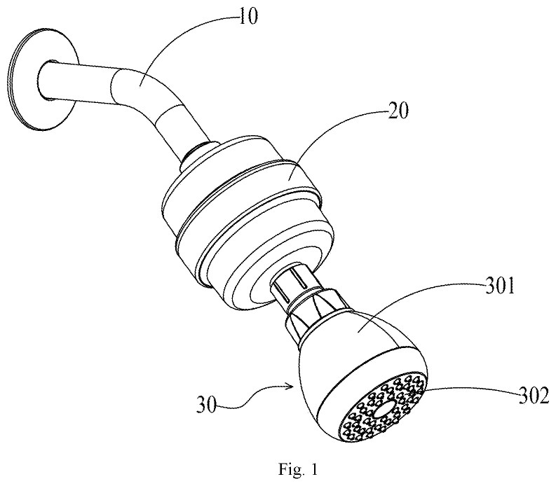

FIG. 2 is a combined perspective view in an embodiment of the present disclosure;

FIG. 3 is an exploded perspective view in the embodiment of the present disclosure;

FIG. 4 is a cross-sectional view in the embodiment of the present disclosure;

FIG. 5 is a combined perspective view in an embodiment of the present disclosure (a filter assembly is located at an upper side of a water passing pipeline);

FIG. 6 is a combined perspective view in an embodiment of the present disclosure (a filter assembly is located at one side of the water passing pipeline); and

FIG. 7 is a combined perspective view in an embodiment of the present disclosure (a filter assembly is located at the other side of the water passing pipeline).

### DESCRIPTION OF REFERENCE NUMERALS

Water passing pipeline 1, connecting arm 11, water passing body 12, C-shaped hole 121, filter assembly 2, housing 21, first housing 211, second housing 212, filter element 22, water outlet assembly 3, handle 31, shower head body 32, water outlet panel 33, hose 4, ball joint 5, connecting part 51, ball head 52, spherical sleeve 53, spherical pad 54, and connecting nut 6.

### DETAILED DESCRIPTION

Embodiments of the present disclosure are described in detail below, and examples of the embodiments are shown in the drawings, wherein the same or similar numerals throughout represent same or similar elements or elements having the same or similar functions. The embodiments described below with reference to the drawings are exemplary, and are intended to be used for explaining the present disclosure, and are not to be understood as limiting the present disclosure.

In order to better understand the above technical solutions, exemplary embodiments of the present disclosure will be described in more detail below with reference to the drawings. Although the exemplary embodiments of the present disclosure are illustrated in the drawings, it should be understood that the present disclosure may be implemented in various forms and should not be limited by the embodiments set forth herein. On the contrary, these embodiments are provided such that the present disclosure will be more thoroughly understood, and the scope of the present disclosure can be fully conveyed to those skilled in the art.

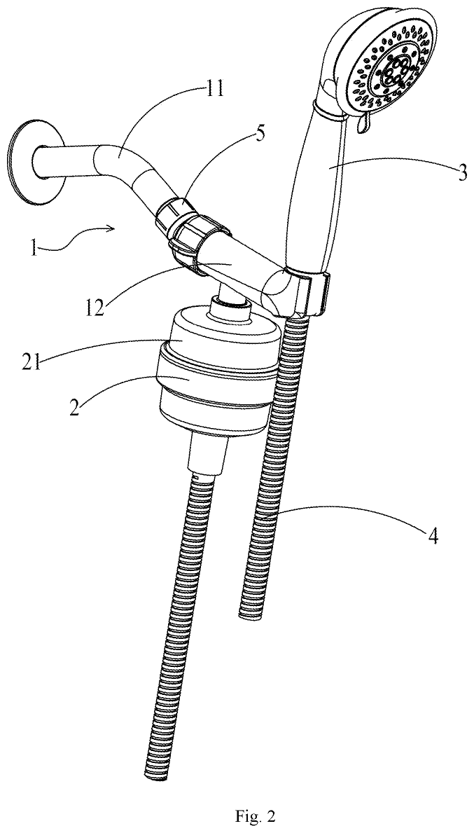

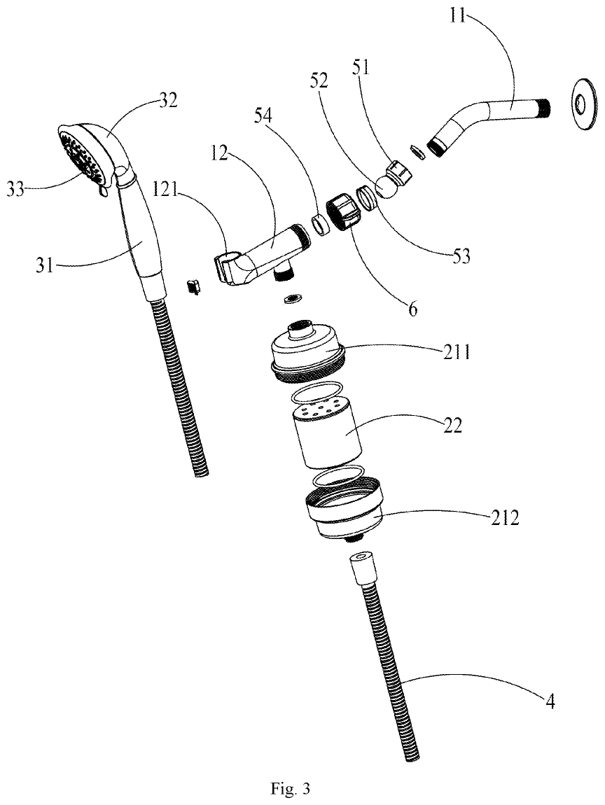

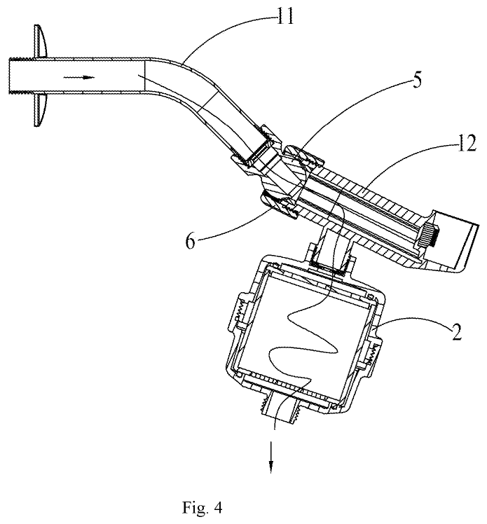

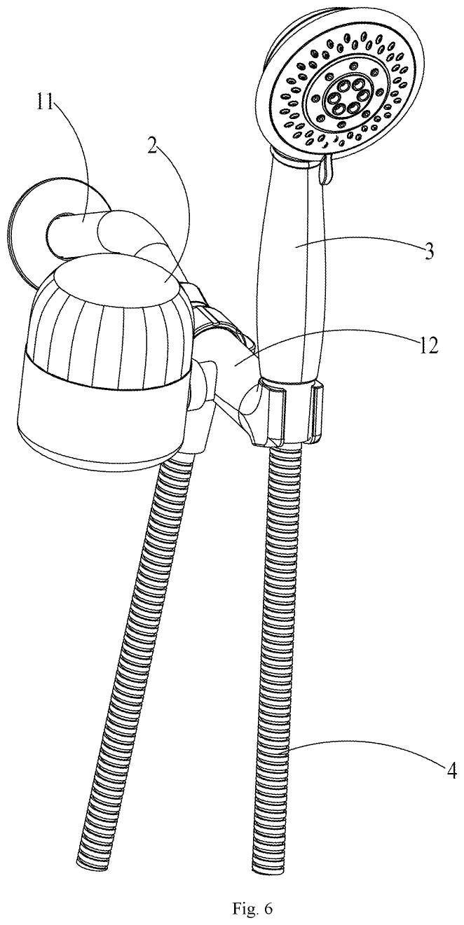

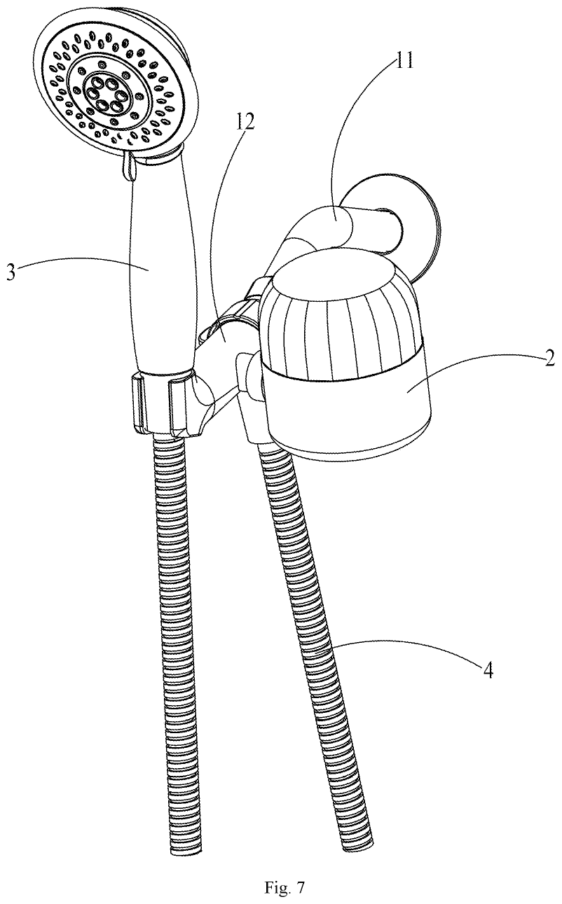

As shown in FIGS. 2 to 7, a shower apparatus according to an embodiment of the present disclosure includes a water passing pipeline 1, a filter assembly 2, and a water outlet assembly 3.

A water inlet end of the water passline pipeline 1 is configured to be connected with a water inlet pipe disposed on a wall, and a flange is arranged between the water passing pipeline 1 and the wall when the water passing pipeline 1 is connected with the water inlet pipe.

A water inlet end of the filter assembly 2 is connected to a water outlet end of the water passing pipeline 1, and a water outlet end of the filter assembly 2 is connected to a water inlet end of a hose 4. The filter assembly 2 is configured to filter a water stream to filter out impurities, harmful substances to the skin and the like from the water stream.

In this embodiment, the filter assembly 2 includes a housing 21 and a filter element 22 disposed in the housing 21, wherein the filter element 22 includes a residual chlorine removal filter element, a bacteriostatic filter element, a VC filter element, a KDF filter element, a mineralization filter element, a hydrogen-rich filter element, a fluorine removal filter element, a metasilicic acid filter element, a scale inhibition filter element, an alkaline filter element, and a fragrance filter element. Specifically, the filter element 22 includes a PP cotton filter element, an activated carbon filter element, a VC filter element, a KDF filter element, a zeolite filter element, a quartz sand filter element, a mineralized ball filter element, a Maifanshi filter element, a magnetic energy ball filter element, a ceramic ball filter element, an alkaline ball filter element, a calcium sulfite filter element, a germanium ball filter element, and a tourmaline filter element. The filter element 22 may have the function of removing residual chlorine from water, may also have skin benefiting functions such as whitening, fragrancing, and the like, and may also have other functions. A water inlet end of the housing 21 is connected to the water passing pipeline 1, and a water outlet end of the housing 21 is connected to the hose 4. Specifically, the housing 21 is provided as a first housing 211 and a second housing 212, wherein the first housing 211 is in threaded connection with the second housing 212, the first housing 211 is connected to the water passing pipeline 1, and the second housing 212 is connected to the hose 4.

A water inlet end of the water outlet assembly 3 is connected to a water outlet end of the hose 4, and the water outlet assembly 3 is hung on the water passing pipeline 1. In this embodiment, the water outlet assembly 3 is a shower head, wherein the shower head includes a handle 31, a shower head body 32 and a water outlet panel 33; a water inlet end of the shower head body 32 is connected to the handle 31, and a water outlet end of the shower head body 32 is connected to the water outlet panel 33; and the handle 31 is connected to the hose 4.

In this embodiment, the water passing pipeline 1 includes a connecting arm 11 and a water passing body 12, wherein the connecting arm 11 is arranged in a bent shape, a water inlet end of the connecting arm 11 is configured to be connected with the water inlet pipe disposed on the wall, a ball joint 5 is connected between a water outlet end of the connecting arm 11 and a water inlet end of the water passing body 12, so that the water passing body 12 rotates at any angle relative to the connecting arm 11, and a water passing channel communicating the connecting arm 11 with the water passing body 12 is formed in the ball joint 5. A water outlet end of the water passing body 12 is connected to the water inlet end of the filter assembly 2, the water passing body 12 is connected to the water outlet assembly 3, in particular, the water outlet assembly 3 is hung on the water passing body 12. In particular, the water passing body 12 is provided with a C-shaped hole 121, the C-shaped hole 121 is specifically formed by forming a perforated hole along the water passing body 12, and performing slot shaping on a side wall of the perforated hole by digging, and the C-shaped hole 121 is configured to place the water outlet assembly 3, in particular, the hose 4 is inserted into the C-shaped hole 121, thereby hanging the water outlet assembly 3 on the water passing pipeline 1.

In other embodiments, the water outlet end of the connecting arm 11 is connected to a connecting part 51 of the ball joint 5, which may be in threaded connection. A ball head 52 of the ball joint 5 is received in a connecting nut 6 and rotatably connected to the connecting nut 6, and the connecting nut 6 is in threaded connection with the water inlet end of the water passing body 12. Further, a spherical sleeve 53 is arranged between the ball head 52 of the ball joint 5 and the connecting nut 6 so that the ball joint 5 can rotate on the spherical sleeve 53 without detachment, and a spherical pad 54 is arranged between the ball head 52 of the ball joint 5 and the water inlet end of the water passing body 12 so that the ball joint 5 can rotate on the spherical pad 54.

In use of the filter arm support device of the present disclosure, water flows through the water passing pipeline 1, enters the filter assembly 2, is filtered by the filter assembly 2, and enters the water outlet assembly 3 through the hose 4, and water spray is sprayed out from the water outlet assembly 3; specifically, water flows through the connecting arm 11, enters the water passing body 12 through the water passing channel of the ball joint 5, enters the first housing 211, the filter element 22 and the second housing 212 of the filter assembly 2 in sequence through the water passing body 12, and enters the handle 31, the shower head body 32 and the water outlet panel 33 of the water outlet assembly 3 in sequence through the hose 4 from the second housing 212, and water spray is sprayed out from the water outlet panel 33. Because the hose 4 is connected between the filter assembly 2 and the water outlet assembly 3, and the water outlet assembly 3 is hung on the water passing pipeline 1, the height of the water outlet assembly 3 is higher than the height of the water passing pipeline 1.

Thus, in the present disclosure, by connecting the water outlet assembly 3 with the filter assembly 2 by means of the hose 4, and hanging the water outlet assembly 3 which can be freely taken down, the height of the water outlet assembly 3 is higher than the height of the water passing pipeline 1, so that the height of the water outlet assembly 3 from the ground is not limited, and the water outlet assembly 3 does not touch the head even when the filter arm support device is used by a taller user, while the water outlet assembly 3 can be taken down when the filter arm support device is used by a shorter user, so that the use is more comfortable.

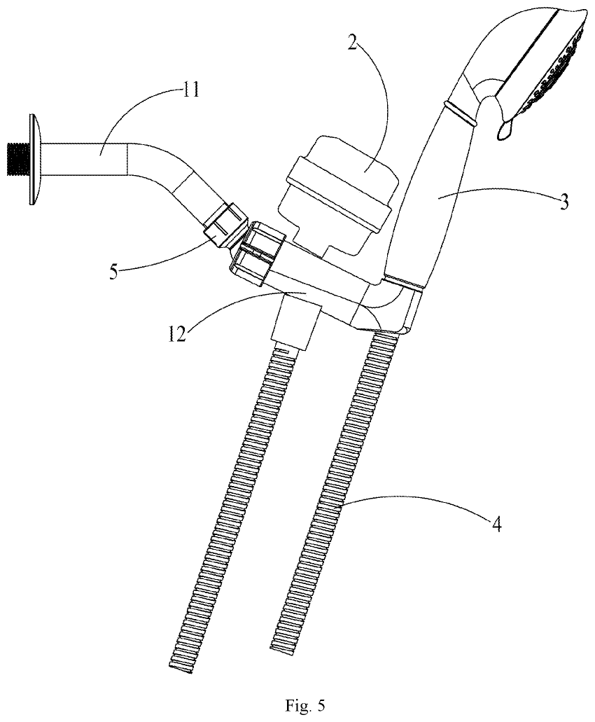

In other embodiments, the filter assembly 2 is arranged at an upper side, close to the water outlet assembly 3, in the middle of the water passing pipeline 1, as shown in FIG. 5, or the filter assembly 2 is arranged at a lower side, away from the water outlet assembly 3, of the water passing pipeline 1, as shown in FIG. 2, the lower side being opposite to the upper side. The filter assembly 2 may also be arranged at a side of the water passing pipeline 1, for example, the filter assembly 2 is arranged at a first side, adjacent to the upper side, of the water passing pipeline 1, and is, for example, arranged at a left side of the water passing pipeline 1, or the filter assembly 2 may also be arranged at a second side, adjacent to the upper side, of the water passing pipeline 1, and is, for example, arranged at a right side of the water passing pipeline 1, the second side being opposite to the first side.

In the description of the present disclosure, it needs to be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” and the like indicate an orientation or positional relationship based on the orientation or positional relationship shown in the drawings, and are only for ease of description of the present disclosure and for simplicity of description, and are not intended to indicate or imply that the device or element referred to must have a particular orientation, and be constructed and operate in a particular orientation, and therefore cannot be construed as limiting the present disclosure.

Furthermore, the terms “first” and “second” are used for descriptive purposes only, and cannot be understood as indicating or implying relative importance or implying the number of technical features indicated. Thus, features defined with “first” and “second” may explicitly or implicitly include one or more of the features. In the description of the present disclosure, “a plurality of” means two or more, unless expressly and specifically defined otherwise.

In the present disclosure, unless expressly specified and limited otherwise, the terms such as “installed”, “connected”, “connection”, “fixed” and the like should be broadly understood, for example, it may be fixed connection, detachable connection or integrated connection; it may be mechanical connection or electric connection; and it may be direct connection or indirect connection through an intermediate medium, and may be internal communication of two elements or an interaction relationship between two elements. For those of ordinary skill in the art, the specific meaning of the above terms in the present disclosure may be understood according to specific situations.

In the present disclosure, unless definitely specified and defined otherwise, a first feature being “above” or “below” a second feature may include that the first feature and the second feature are in direct contact or that the first feature and the second feature are not in direct contact but are in contact through another feature therebetween. Moreover, a first feature being “above”, “over”, and “on” a second feature includes that the first feature is right above and obliquely above the second feature, or only indicates that the first feature is at a higher level than the second feature. A first feature being “below”, “beneath” and “under” a second feature includes that the first feature is directly below and obliquely below the second feature, or only indicates that the first feature is at a lower level than the second feature.

In the description in this specification, the description of reference terms “one embodiment”, “some embodiments”, “an example”, “a specific example”, or “some examples” or the like means that particular features, structures, materials, or characteristics described in combination with the embodiment or example are included in at least one embodiment or example of the present disclosure. In this specification, illustrative description of the above terms should not be understood as necessarily referring to the same embodiment or example. Moreover, the specific features, structures, materials, or features described may be combined in any one or more embodiments or examples in a suitable manner. Furthermore, different embodiments or examples described in this specification may be joined and combined by those skilled in the art.

Although the embodiments of the present disclosure have been shown and described above, it can be understood that the above embodiments are illustrative and not to be construed as limiting the present disclosure. Those of ordinary skill in the art may make changes, modifications, substitutions, and variations to the above embodiments within the scope of the present disclosure.

What is claimed is:

1. A shower apparatus, comprising:
a water passing pipeline, wherein a water inlet end of the water passing pipeline is configured to be connected with a water inlet pipe disposed on a wall;
a filter assembly, wherein a water inlet end of the filter assembly is connected to a water outlet end of the water passing pipeline, and a water outlet end of the filter assembly is connected to a water inlet end of a hose; and
a water outlet assembly, wherein a water inlet end of the water outlet assembly is connected to a water outlet end of the hose, and the water outlet assembly is hung on the water passing pipeline.

2. The shower apparatus according to claim 1, wherein the water passing pipeline comprises a connecting arm and a water passing body, wherein a water inlet end of the connecting arm is configured to be connected with the water inlet pipe disposed on the wall, and a ball joint is connected between a water outlet end of the connecting arm and a water inlet end of the water passing body; and a water outlet end of the water passing body is connected to the water inlet end of the filter assembly, and the water passing body is connected to the water outlet assembly.

3. The shower apparatus according to claim 2, wherein the water outlet end of the connecting arm is connected to a connecting part of the ball joint, a ball head of the ball joint is received in a connecting nut and rotatably connected to the connecting nut, and the connecting nut is in threaded connection with the water inlet end of the water passing body.

4. The shower apparatus according to claim 3, wherein a spherical sleeve is arranged between the ball head of the ball joint and the connecting nut, and a spherical pad is arranged between the ball head of the ball joint and the water inlet end of the water passing body.

5. The shower apparatus according to claim 2, wherein the water passing body is provided with a C-shaped hole for placing the water outlet assembly.

6. The shower apparatus according to claim 5, wherein the water outlet assembly is a shower head, wherein the shower head comprises a handle, a shower head body and a water outlet panel; a water inlet end of the shower head body is connected to the handle, and a water outlet end of the shower head body is connected to the water outlet panel; and the handle is connected to the hose, and the hose is inserted into the C-shaped hole.

7. The shower apparatus according to claim 1, wherein the filter assembly comprises a housing and a filter element disposed in the housing, wherein a water inlet end of the housing is connected to the water passing pipeline, and a water outlet end of the housing is connected to the hose.

8. The shower apparatus according to claim 7, wherein the filter element comprises a residual chlorine removal filter element, a bacteriostatic filter element, a VC filter element, a KDF filter element, a mineralization filter element, a hydrogen-rich filter element, a fluorine removal filter element, a metasilicic acid filter element, a scale inhibition filter element, an alkaline filter element, and a fragrance filter element.

9. The shower apparatus according to claim 7, wherein the housing is provided as a first housing and a second housing, wherein the first housing is in threaded connection with the second housing, the first housing is connected to the water passing pipeline, and the second housing is connected to the hose.

10. The shower apparatus according to claim 1, wherein the filter assembly is arranged at an upper side, close to the water outlet assembly, in the middle of the water passing pipeline, or the filter assembly is arranged at a lower side, away from the water outlet assembly, of the water passing pipeline, the lower side being opposite to the upper side.

11. The shower apparatus according to claim 10, wherein the filter assembly is arranged on a first side, adjacent to the upper side, of the water passing pipeline, or the filter assembly is arranged on a second side, adjacent to the upper side, of the water passing pipeline, the second side being opposite to the first side.
